(19) United States
(12) Patent Application Publication
(10) Pub. No.: US 2011/0017840 A1
(43) Pub. Date: Jan. 27, 2011

(54) Grafitti Prevention System

(75) Inventor: Anthony George Bicknell, Red Hill (NZ)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Sabian Family Trust, Havelock North (NZ)

(21) Appl. No.: 12/895,320

(22) Filed: Sep. 30, 2010

Related U.S. Application Data
(63) Continuation-in-part of application No. 12/066,378, filed on Sep. 2, 2008, now abandoned.

(51) Int. Cl. B05B 1/30

(52) U.S. Cl. 239/67

(57) ABSTRACT

A graffiti prevention apparatus for preventing application of graffiti to a surface(s). The apparatus includes a control component (11) coupled to one or more modular components (21, 31). The control component (11) has a solenoid valve (12) which is coupled to a liquid supply. A motion sensor (19) upon sensing movement near surface(s) activates the solenoid valve (12) to cause liquid to flow from a supply line (13) to spray pipes (14) so that liquid issues from spray producing nozzles (15, 16) onto the surface(s) to prevent graffiti from being applied to surface(s)

### CROSS-REFERENCE TO RELATED APPLICATION

The present non-provisional application is a continuation-in-part of and claims priority from U.S. patent application Ser. No. 12/066,378, filed Sep. 2, 2008, which is a non-provisional application of Patent Cooperation Treaty Application No. PCT/NZ2006/000233, filed Sep. 8, 2006.

### BACKGROUND

There are many bare surfaces visible in populated areas, such as the sides of large buildings or other expansive structures, for example, over-bridges.

Unfortunately, some members of the public consider it necessary to “decorate” or deface these surfaces with unauthorized writing or drawing, whether artistic or otherwise. Portable cans of propellant spray paint are generally used by these persons, who are generally known as “taggers”.

Graffiti on buildings is damaging and unsightly. Also, graffiti is potentially very costly and time consuming for building owners and/or tenants to remove, as the graffiti must be cleaned off, and the surface made good to match the surrounding surface.

There are various passive means that have been developed to protect a buildings exterior surface from graffiti. One method is by the application of an anti-graffiti coating, which, when applied to a surface, prevents spray paint from adhering to the surface. Therefore, a building owner/person may more easily remove the graffiti from the surface.

It is unfortunate that taggers are very persistent, and in areas where graffiti is removed, it is quite likely that those areas will be targeted, and thus, the tagging will, most probably continue.

Thus traditional anti graffiti measures have a number of disadvantages. One disadvantage is that anti graffiti coatings are a passive measure, and they do not prevent a tagger from applying graffiti to the surface.

A second disadvantage is that building's surfaces to which an anti graffiti coating is applied, merely allows a building owner or tenant to remove the graffiti from the building surface in a less labor intensive, and less time consuming manner.

### SUMMARY

The present invention provides an active graffiti prevention apparatus that is associated with a vertical surface which may be a target for graffiti, but can be activated to prevent the application of graffiti to the surface.

Broadly, according to one aspect of the invention there is provided graffiti prevention apparatus comprising a motion sensing means configured to sense the presence of a person prior to arrival at a guided wall section to which the apparatus is mounted, a controllable valve for a liquid supply, a supply line coupled to an inlet of the controllable valve and configured to be capable of being coupled to a pressurized liquid supply, a spray line coupled to an outlet of the valve, and a plurality of nozzles coupled to the spray line and comprising at least one mist producing nozzle configured for creating a mist near the guarded wall section for diluting a paint spray; and at least one spray producing nozzle configured for generating a liquid spray that creates a run-off down the guarded wall section at a flow rate of at least 2 m/s to prevent paint from the paint spray adhering to the guarded wall section wherein the controllable valve is configured to be operable to the motion sensing means to permit the flow of fluid from the supply line to the spray line.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a front elevation of a vertical surface with which the graffiti prevention apparatus of the present invention is associated,

FIG. 2 is a perspective illustration of the control component of the graffiti prevention apparatus,

FIG. 3 is a schematic top plan view of the graffiti prevention apparatus of FIG. 1 and incorporating the control component of FIG. 2 and showing the configuration of dispensing nozzles and associated equipment,

FIG. 4 is a cross section end elevation view through the control component of the graffiti prevention apparatus of FIG. 2, and

FIG. 5 is a cross section end elevation view through a left side component (shown schematically in FIG. 3) of the graffiti prevention apparatus of FIG. 1.

### DETAILED DESCRIPTION

The graffiti prevention apparatus 10, according to a one form of the invention, is illustrated in the accompanying drawings. The graffiti prevention apparatus 10 is of a modular construction and includes at least one modular control component 11.

The apparatus 10 is attachable to or adjacent a guarded surface in the form of a vertical wall S, the apparatus being operative to prevent, or a least go some way to deterring a person from applying graffiti to the surface. The apparatus 10 is shown mounted horizontally across a guarded wall section S. However the apparatus 10 could be mounted vertically and/or be used to guard another surface such as a door.

A water supply is located to one side (the left side) of the surface. The water supply couples to the apparatus 10 by way of a supply line 13.

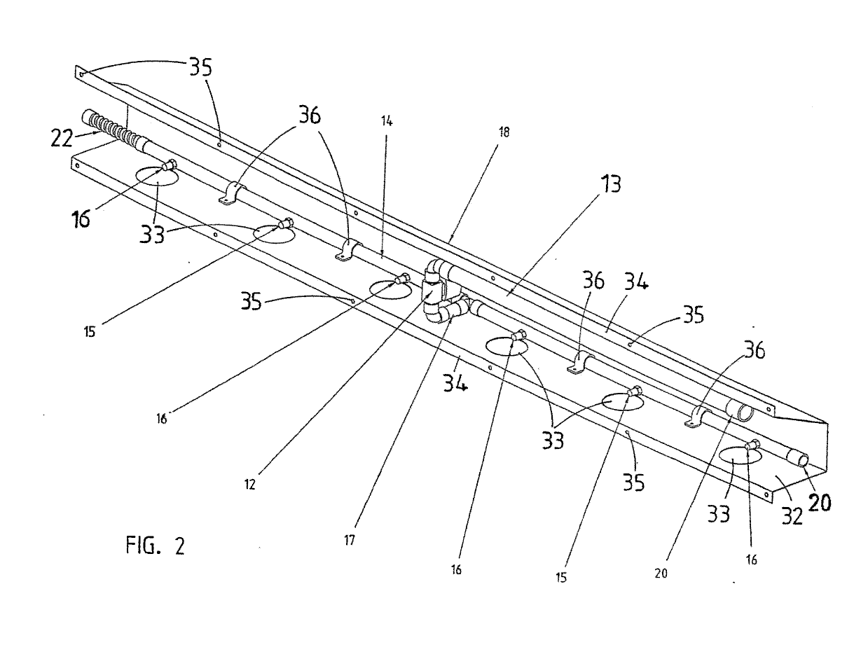

A central modular component 11 is provided which is illustrated in more detail in FIG. 2. This is the so-called control module 11. It contains a controllable valve means in the form of solenoid 12, a length of supply line 13, and a length of spray pipe 14, to which are coupled a plurality of mist producing nozzles 15 and spray producing nozzles 16.

The supply line 13 is of 20 mm internal diameter polybutene pipe, and couples to a mains water line 25. However, this is only by way of example and may vary in diameter without departing from the scope of the present invention.

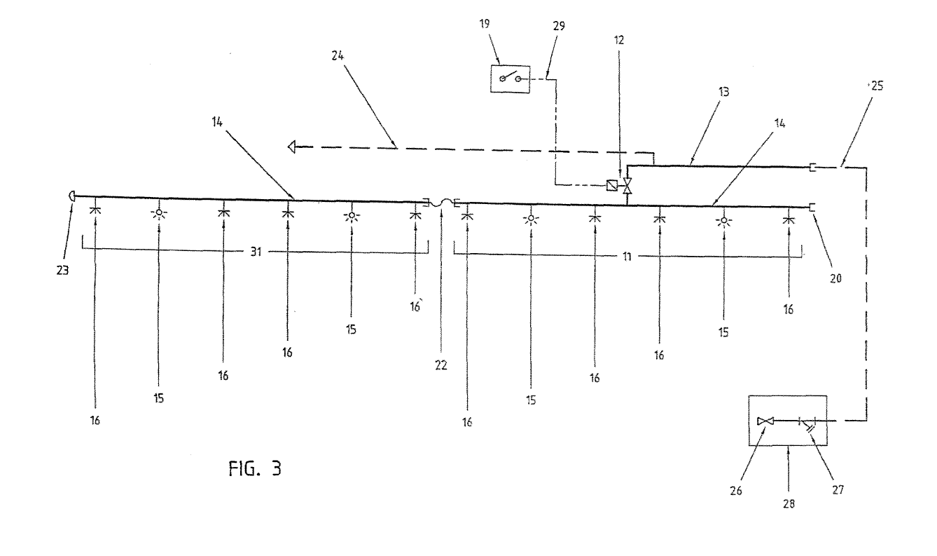

The mains supply couples via an isolation valve 26 to mains water line 25 (see FIG. 3). A filter 27 is provided between the isolating valve 26 and the supply line 13. Preferably, to prevent damage and unauthorized use of the isolation valve 26, a protective cover 28 encloses the filter 27 and isolation valve 26.

The supply line 13 couples to the inlet side of the solenoid 12. Coupled to the outlet side of the solenoid 12 is a transfer pipe 17, the opposing end of which couples centrally to the spray pipe 14 via a suitable watertight connector, as illustrated in FIG. 2.

The transfer pipe 17 and spray pipe 14 are of 15 mm internal diameter polybutene pipe. Once again this is only by way of example.

The sprinkler nozzles 15 and 16 are low cost devices. Thus in one embodiment they can be of a type commonly used in garden irrigation apparatus. A person skilled in the art will appreciate that the nozzle 15, 16 design can be varied to alter the flow rates without departing from the scope of the present invention.

It will be apparent to the skilled addressee that there are many different types of sprinkler nozzles available which allow a user to select a desired spray pattern and water flow rate. As is disclosed herein, a first spray nozzle provides a fine spray, whilst a second spray nozzle is of a high flow, in order to drench the surface S.

The mist producing nozzles 15 and spray producing nozzles 16 can be coupled to the spray pipe 14, in the interspersed configuration as illustrated in FIG. 3. This interspersed configuration is arranged so that a mist producing nozzle 15 is located between a pair of spray producing nozzles 16. A person skilled in the art will appreciate that other arrangements can be formed without departing from the scope of the present invention.

The inventors have found through trial and error that a the apparatus 10 functions optimally when the mist producing nozzles 15 produce a 1.5 second burst of mist at between 100 and 135 psi fluid pressure. The flow rate of approximately 5 liters per second is needed to the mist producing nozzles 15. The spray producing nozzles 16 require a fluid pressure of between 20 and 80 psi at a flow rate of at least 1 liter per second to produce a fluid runoff from the guarded wall section S of at least 2 meter per second (m/s). This combination of parameters is sufficient to dilute the aerosol from a paint spray with the mist produced from the mist producing nozzles 15 and prevent the paint spray adhering to the guarded wall surface S with the run-off fluid flow from the spray producing nozzles 16. A fluid runoff of less than 2 m/s on the guarded wall section has been found to not be sufficient to prevent adhering of paint from a paint spray.

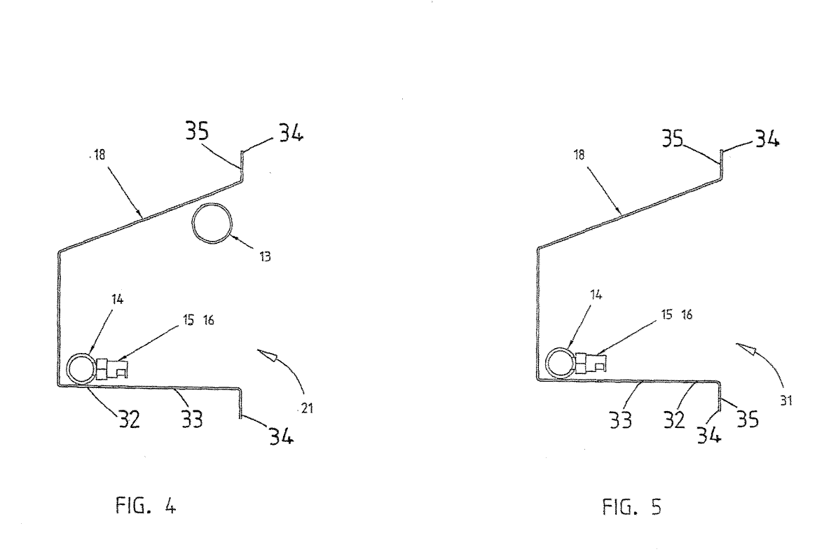

A cover 18 encloses the inner workings of the graffiti prevention apparatus. Preferably, the cover 18 is of a cross-sectional shape as illustrated in FIG. 4. As shown in FIG. 2 the cover 18 has a lower wall 32 with a series of openings 33 an opening being adjacent the outlet of each of the spray producing nozzles 15/16.

It will be apparent to the skilled addressee that the cover 18 may be made of any solid (robust) material, such as folded sheet-metal or a rigid plastic type material. The cover 18 may also be of any desired shape, and be of a size that covers the apparatus pipe work and solenoid. Different shape designs could, for example, be employed to suit different building types.

The cover 18 preferably has a mounting means in the form of a pair of flanges 34 (see FIG. 2) with apertures 35 such that the cover 18 can be fixedly mounted to a structure (e.g. the surface S).

The supply line 13 and spray pipe 14, within component 11, are coupled to an inside surface of the cover 18, as illustrated in FIG. 2. As shown, this mounting can be achieved by clips 36 straddling the spray pipe 14. The supply line 13 can be similarly mounted.

The apparatus further includes one or more motion sensing means in the form of passive infrared sensor devices 19. It will be apparent to the skilled addressee that there are many different types of motion sensing devices such as light beam or ultrasonic sensing devices.

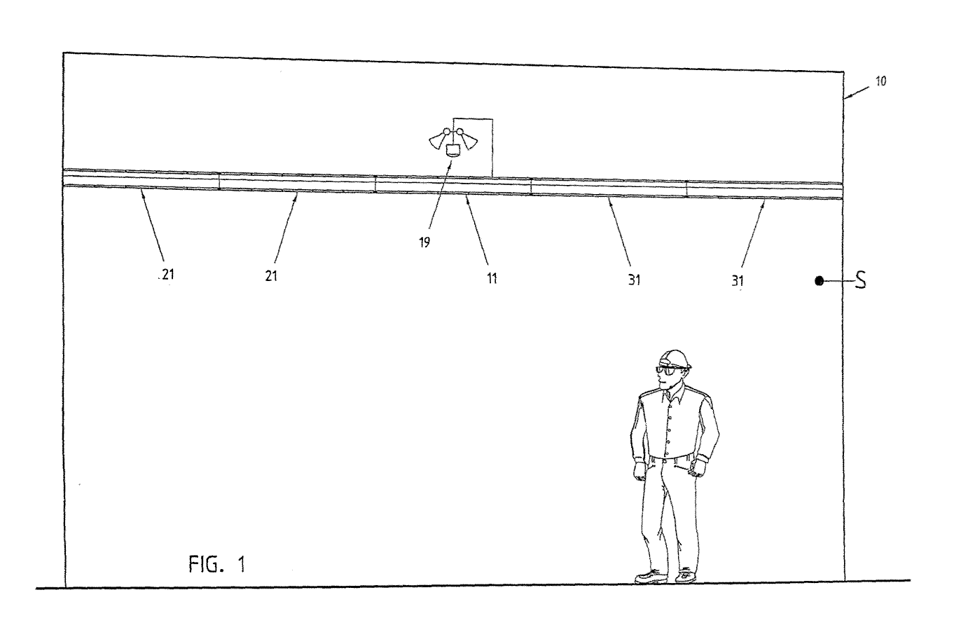

The motion sensing device 19 can be mounted inside cover 18 above the modules 11, 21, 31 (as shown in FIG. 1) to thereby lower the possibility of the sensor(s) being damaged by vandals.

It will be apparent to the skilled addressee that motion sensing device(s) may be connected with high intensity lamps, and timer means. The timer means determines the duration of time the lamps may operate, once the sensor has been triggered. As disclosed herein, a motion sensor comprising at least one high intensity lamp is described as being used.

An alarm (not shown) can also be connected to the apparatus 10 and operable upon the solenoid 12 triggering. The alarm can be visual, such as strobe lights, or audible, such as sirens. The alarm can be fitted inside cover 18 for added protection. The alarm can be manually activated by a user of the apparatus 10 or automatically activated at pre-determined times of the day. The alarm can also take the form of an automatic notification of a security service in the form of a pre-recorded telephone call or text message to a mobile telephone.

The output from the motion sensing device 19 is electrically connected directly, or via a logic controller to the input of the solenoid 12. Thus, when the motion sensor 19 is activated, the solenoid 12 is activated to move from a first (closed) position to a second (open) position.

The motion sensor 19 is preferably attached adjacent the vertical surface S at a level which is unreachable by the general public. It should ideally be located at a position such that the motion sensor(s) coverage area equates to the size of the surface S and the immediate environs of the surface.

Where a surface is wider than a single sensor coverage area, more than one motion sensor 19 may be used.

A cross section through a right side modular component 21 of the graffiti prevention apparatus of FIG. 1 is illustrated in FIG. 4. This module 21 contains a length of supply line 13, and a length of spray pipe 14 with associated nozzles 15, 16.

Any number of right side components 21 may consecutively be coupled to the right side of the control component 11. However, it will be apparent to the skilled addressee that a apparatus of this kind will have certain limitations in regard to water flow in long lengths of pipe.

Where a very wide graffiti prevention apparatus is required, it may be advantageous to provide multiple smaller independent apparatus, located side by side, to protect a vertical surface S. Alternatively, an electric pressure pump can be used to achieve a desired pressure delivery. The pump would preferably be supplied by a reservoir tank controlled by say a ball cock valve, the tank being coupled to the “town” supply. The tank and pump can be mounted either inside or outside the building. The capacity of the tank would be selected at installation of the apparatus 10 depending on the length of the supply line 13 of the apparatus 10 to be installed, for example a 20 liter capacity tank would be used with a 20 meter length of supply line 13 or a 100 liter capacity tank would be used with a 100 meter length of supply line 13. Alternatively, the tank capacity could be a standard size (such as 500 to 1000 liters).

The tank could be rain water filled in addition to being connected to the mains water line 25 to conserve water. The collected rainwater would be filtered before being fed to the pump.

As an alternative, to multiple smaller independent apparatus connected together, it may be advantageous to include a continuation 24 (see FIG. 3) of the water supply pipe, so that mains pressure water may be supplied to subsequent supply lines 13 (not illustrated in the drawings) placed further downstream. This thereby results in the supply line 13 being filled with water over a supply line length that would otherwise be impractical with only one water supply connection to the supply line 13.

Each of the supply line 13 and spray pipe 25 is formed of flexible tubing. It will be apparent to the skilled addressee that there are many different methods of joining lengths of flexible pipe with the large number of connectors commercially available. For example, the connectors may be straight or flexible. As is disclosed herein and with reference to the accompanying drawings, a straight (rigid) connector 20 and/or a flexible connector 22 are described as being used (see FIG. 2).

Assuming the water supply is located at or toward the left side of surface S there will generally be one or more components 21 to the left of the central control unit 11. At the joint of each “right side component” 31, the supply line 13 and spray pipe 14 therein will be coupled together by water tight connectors 20, as illustrated in FIG. 2.

The mist producing nozzles 15 and spray producing nozzles 16 are coupled to the spray pipe 14 within the right side component(s) 31, and arranged in the same manner as illustrated in FIG. 3.

To the right of the central unit 11 there will be one or more right side components 31. These right side components 31 are of the same general construction as a left side component 21. However, the right side component 31 does not contain the supply line 13. A cross section through a right side component 31 is illustrated in FIG. 5.

As described above, any number of left side components 21 may be consecutively coupled to the left side of the control component 11. The spray pipe 14 is joined together in adjacent components 31 by use of connectors as described above.

The joints between adjacent cover sections 18 may be sealed with a suitable weatherproof sealant, or be joined by mechanical fasteners. Generally the end of one cover 18 will overlap with the end of the next adjacent cover 18.

As assembled, the graffiti prevention apparatus 10 may include at least one control component 11, but preferably, at least one right side component 21, and at least one left side component 31 will be coupled to the control component 11.

The graffiti security apparatus will be of a dimension equal to that of the width of the vertical surface S to be protected. This is the type of construction illustrated in FIG. 1.

The control component 11 will generally be located substantially centrally in relation to the width of the vertical surface S. As required, right side components 21 and left side components 31 are coupled end to end to the respective sides of control component 11.

The length of the left and/or right side components 31/21 may be cut to a shorter length to suit the width of vertical surface which is to be protected.

To the exposed ends of the left and right side components 31/21, end caps (not shown in the drawings) may be provided. End caps can fully enclose the pipe-work within the cover 18. These will be fixed in place by use of suitable mechanical fasteners.

Also, the ends of the supply line 13 and spray pipe 14 may be terminated by any suitable means. For example, the end of each respective pipe may be blocked by an end plug 23.

As illustrated in FIG. 1, at least one motion sensor 19 may be attached to or adjacent the vertical surface S. The motor sensor 19 is adjusted so that persons moving in close proximity to the protected portion of vertical surface S will be detected and give rise to activation of the sensor 19.

It can be appreciated that at certain times, it may be undesirable for the graffiti prevention apparatus 10 to be operational, such as in times of high pedestrian flow past the protected surface. To accomplish this, a second timer means may be provided, connected in such a manner as to disable or enable the apparatus as desired. Alternatively, a logic controller forming part of the apparatus may have light sensing means to turn off the apparatus during daylight periods. The logic controller would have a timer function to control when the apparatus 10 would be functioning at predetermined periods in the day. A counter function would record when the apparatus 10 was activated. The logic controller would control the maximum run-time of the apparatus 10 after activation by the sensing means 19 to prevent continuous running of the apparatus 10 as a result of malfunction.

In use, the graffiti prevention apparatus 10 is attached to or adjacent the full width of a surface S to be protected, and located at a height above the reach of the general public.

When the graffiti prevention apparatus 10 is operational, a tagger may approach the vertical surface S, having the intention to deface the surface with eg. a can of spray paint. When the tagger comes into range of the motion sensor 19, the motion sensor 19 activates.

Upon activation of the motion sensor, an electrical signal is sent from the motion sensor 19 to the water solenoid 12 (or a control unit coupled to solenoid 12) via electrical cable 29. Also, when the motion sensor 19 activates, the high intensity lamp, included with the motion sensor 19, illuminates the vertical surface S. This is a first deterrent to the tagger, as a tagger may be anxious about tagging a well lit surface.

Also, if an alarm is fitted this will activate and may deter the tagger.

The water solenoid 12 will open thereby allowing water to flow from the supply line 13 into spray pipe 14.

The supply line 13 is of a greater diameter than the spray pipe 14. Thus, as a large volume of water flows from the supply line 13 into the spray pipe 14, the water pressure will, within the narrower diameter spray pipe 14, be higher than that within the supply line 13. Therefore, water will be supplied relatively quickly to mist producing nozzles 15 and spray producing nozzles 16.

As the spray pipe 14 is quickly filled, water will thus flow out of each spray nozzle 16 coupled to the spray pipe 14, effectively drenching the vertical surface S with a stream of water. Water will also flow out of the mist producing nozzles 15. The mist will float down in close proximity to the vertical surface S.

It is intended that water from the mist producing nozzles 15 will create a mist near the guarded wall section S for diluting a paint spray before the tagger has reached surface S. Similarly water from the spray producing nozzles 16 will drench the vertical surface S before the tagger has reached surface S.

As the tagger is attempting to spray the surface S with the spray paint, the water droplets within the mist will interact with a stream of spray paint, resulting in the water mist diluting the stream of spray paint. Any spray paint that does contact the wet wall surface will not adhere to the surface, and will subsequently be washed away.

As paint will not adhere to a wet surface, the tagger can get no satisfaction in defacing the surface. Therefore, the tagger will, most probably, choose an “easier” target.

The motion sensor 19 may be adjusted so that it is more or less sensitive to movement. Also, a timer means may be included in the motion sensor 19 to allow setting of the duration of time the activated apparatus may be allowed to operate for.

Once the desired operating time has elapsed, an electrical signal is sent from the timer means to the solenoid 12, thus deactivating the solenoid and shutting off the water supply.

The graffiti prevention apparatus 10 is open to modification, as will be apparent to the skilled addressee.

According to another embodiment, a security camera (not shown) may be included with the graffiti prevention apparatus 10. The security camera, once activated by the motion sensor 19, may send images of the protected area to a central monitoring location, or to a remote storage means for later review. Alternatively, the security camera may activate the solenoid 12 based on image processing. The camera may also monitor the operation of the apparatus 10.

According to yet another embodiment, a water meter may be fitted into the supply line 13. Thus, an operator of the apparatus may monitor the apparatus water usage. This is particularly useful for users who must pay for mains water reticulation.

According to another embodiment the mains pressure pipe may be enclosed by a protective cover.

The apparatus 10 may be supplied as a kit of parts (not shown) for self-installation or installed from a service provider. Different kits can be supplied to suit different styles of building. For example a standard kit can be used for residential buildings which comprise components which are more slim line and aesthetically pleasing (for example a colored plastic or aluminum cover 18); or an industrial kit can be used for commercial buildings which comprise components made for improved strength. Alternatively a kit can be supplied for serviceable parts of the apparatus 10 (such as sensing means, solenoid 12 and/or pump.

The present invention provides a low cost and easily installed solution to prevent graffiti being applied to the vertical surface.

The apparatus can be easily attached to a building, and is cost effective to operate.

To illustrate the effectiveness of the graffiti prevention apparatus, a prototype version was installed onto the frontage of a shop. Prior to fitment of the apparatus, graffiti was continually applied to the shop frontage. Once the graffiti prevention apparatus was fitted to the shop frontage, the shop frontage has remained graffiti free.

A further use of the apparatus is that it can work as an external fire retardant as the sensors will pick up the heat signature of any fire close to the building. This can cause the apparatus to activate and keep the wall wet until the first signature has gone or the fire is put out.

Thus the embodiments of the present invention provide the advantage over the prior art of enabling a guarded section of wall to remain clean and free from graffiti and dirt.

1. A graffiti prevention apparatus comprising:
a motion sensing means configured to sense the presence of a person prior to arrival at a guided wall section to which the apparatus is mounted,
a controllable valve for a liquid supply,
a supply line coupled to an inlet of the controllable valve and configured to be capable of being coupled to a pressurized liquid supply
a spray line coupled to an outlet of the valve, and
a plurality of nozzles coupled to the spray line and comprising:
at least one mist producing nozzle configured for creating a mist near the guarded wall section for diluting a paint spray; and
at least one spray producing nozzle configured for generating a liquid spray that creates a run-off down the guarded wall section to prevent paint from the paint spray adhering to the guarded wall section;
wherein the controllable valve is configured to be operable to the motion sensing means to permit the flow of fluid from the supply line to the spray line.

2. A graffiti prevention apparatus comprising:
a motion sensing means configured to sense the presence of a person prior to arrival at a guided wall section to which the apparatus is mounted,
a controllable valve for a liquid supply,
a supply line coupled to an inlet of the controllable valve and configured to be capable of being coupled to a pressurized liquid supply
a spray line coupled to an outlet of the valve, and
a plurality of nozzles coupled to the spray line and comprising:
at least one mist producing nozzle configured for creating a mist near the guarded wall section for diluting a paint spray; and
at least one spray producing nozzle configured for generating a liquid spray that creates a run-off down the guarded wall section at a flow rate of at least 2 m/s to prevent paint from the paint spray adhering to the guarded wall section;
wherein the controllable valve is configured to be operable to the motion sensing means to permit the flow of fluid from the supply line to the spray line.

3. The apparatus as claimed in claim 1 wherein the pressurized liquid supply is supplied to the mist producing nozzles at a pressure of between 100 and 135 psi.

4. The apparatus as claimed in claim 1 wherein pressurized liquid supply is supplied to the spray producing nozzles at a pressure of between 20 and 80 psi.

5. The apparatus as claimed in claim 1 wherein each of the supply line comprises a pressure manifold and is of a greater diameter than that of the spray line.

6. The apparatus as claimed in claim 1 wherein the apparatus also comprises a liquid storage tank and a pump configured to supply the pressurized liquid supply to the spray line.

7. The apparatus as claimed in claim 1 wherein at least the spray pipe and valve are housed within a cover to form a control component, the cover having openings through which spray issuing from the nozzles can exit the cover.

8. The apparatus as claimed in claim 7 wherein one or more modular components comprising a cover, spray pipe and spray producing nozzles are connected to the control component.

9. The apparatus as claimed in claim 7 wherein the covers of adjacent control component and modular components are coupled together.

10. The apparatus as claimed in claim 8 wherein one or more of the modular components include a supply line coupled together to the supply line of the control component.

11. The apparatus as claimed in claim 1 wherein the spray producing nozzles and the mist producing nozzles are interspersed along the spray pipe.

12. The apparatus as claimed in claim 1 wherein the spray producing nozzles and mist producing nozzles are arranged in repeating groups with each group consisting of a mist producing nozzle located between a pair of spray producing nozzles.

13. The apparatus as claimed in claim 1 further comprising one or more lights coupled to and activated by the motion sensing means.

14. The apparatus as claimed in claim 1 further comprising an audible alarm activated by the motion sensing means.

15. The apparatus as claimed in claim 1 further comprising a camera activated by the motion sensing means.

16. The apparatus as claimed in claim 1 further comprising a water meter fitted to the supply line.

17. The apparatus as claimed in claim 1 further comprising a timer fitted to the motion sensing means.

18. The apparatus as claimed in claim 1 further comprising an isolating valve fitted to the supply line.

19. The apparatus as claimed in claim 1 further comprising a filter fitted between the isolating valve and the supply line.
